(19) United States
(12) Patent Application Publication
(10) Pub. No.: US 2007/0011470 A1
(43) Pub. Date: Jan. 11, 2007

(54) Method and apparatus for rendering multimedia data objects

(75) Inventors: Johannis Friso Rendert Blacquiere, Eindhoven (NL); Jozef Pieter Van Gassel, Eindhoven (NL); Declan Patrick Kelly, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,605

(22) PCT Filed: Nov. 29, 2004
(86) PCT No.: PCT/IB04/52584

§ 371 Date: Jun. 19, 2006

(30) Foreign Application Priority Data
Dec. 22, 2003 (EP) 03104909.1

(51) Int. Cl. G06F 1/00

(52) U.S. Cl. 713/300

(57) ABSTRACT

Portable devices for rendering multimedia data objects are widely known; mainly for reproducing audio, but also for reproducing video. These devices are powered by battery, which is known to have a limited amount of energy available. This carries the risk that no energy is available any more, while a multimedia data object that is rendered, is not rendered in full this leaves a user unsatisfied. Therefore, the amount of energy of the battery is checked and when a multimedia data object selected to be rendered can be rendered in full, it is rendered. When it cannot be rendered in full, it is not rendered. In an embodiment according to the invention, this check is made for a group of selected multimedia data objects.

The invention relates to a method of rendering multimedia data objects by a rendering circuit powered by a battery.

The invention furthermore relates to a circuit for rendering multimedia data objects being powered by a battery.

The invention also relates to an apparatus for rendering multimedia data objects comprising such circuit.

GB 2 378 862 A discloses a control and management method for the status of a battery in a portable multimedia device. Data is processed in a way that needs only a part of the energy left in the battery or in away using a larger amount of energy. In an embodiment of the method, only I-frames of a video stream are rendered to use less energy; this is for example done when there is not enough energy left for rendering the full video stream.

This method may be an option when video is not a main part of data to be rendered and comprises not a lot of information. However, when only about 10% of the frames is rendered, at least the embodiment described is not an option to be used for rendering of films. Also when classical music is to be rendered, it is not an option to play back the music in a reduced or summarized format as a user will miss apparently less vital, subtle parts of the music which may in some cases by just as annoying, as the case where only 10% is played back.

It is an object of the invention to provide a method that ensures that when selected multimedia data objects are rendered, they are rendered in full with the amount of energy left in the battery. To achieve this object, the invention provides a method comprising the steps of: providing a list of at least one reference to at least one multimedia data object scheduled for rendering by the rendering circuit; determining the amount of energy needed for rendering the multimedia data object referenced in the list; determining the amount of energy that can be provided by the battery; and rendering the multimedia data object for rendering when the amount of energy that can be provided by the battery is equal to or more than the amount of energy needed for rendering the multimedia data object.

This implies that multimedia data objects that cannot be rendered in full will not be rendered, although they are selected for rendering. This prevents disappointments of a user using an apparatus applying the method according to the invention. When the battery providing energy to the apparatus has no more energy left while a multimedia data object is not yet fully rendered, a user may miss vital parts of the multimedia data object to be rendered, like the plot of a film, which is very annoying. However, also the miss of apparently less vital, subtle parts of the multimedia data object may in some cases by just as annoying, like for example with a classical concert.

In an embodiment of the method according to the invention, the list comprises a multitude of references to multimedia data objects and the method further comprises the step of selecting a group of multiple multimedia data objects that can be rendered in total with the amount of energy that can be provided by the battery.

When the multimedia data objects are relatively small, they comprise for example mainly music compressed according to the MP3 standard (MPEG-1, layer 3 audio encoding) and the battery is still quite full, multiple multimedia data objects can be rendered with the amount of energy still left in the battery (current-solid state mp3 players are able to play 10 hours of music with the energy that can be provided by one AAA sized battery). When a group of interrelated multimedia data objects is selected, for example various pieces of a concert, it is desirable that the full selection can be played back with the amount of energy that can be provided by the battery.

In a further embodiment of the method according to the invention, the apparatus further comprises a display and the method further comprises the steps of: displaying the list on the display; and highlighting a group of references to multimedia data objects that can all be rendered with the amount of energy that can be provided by the battery.

This embodiment provides the advantage that a user is informed on the full list of items that can be rendered with the given amount of energy in the battery.

In again a further embodiment of the invention, the method further comprises the step of indicating that the selected object can be rendered in full with the amount of energy left in the battery.

According to the invention, a multimedia data object that cannot be rendered in full with the amount of energy left in the battery is just not played. A user might have to guess why this is the case, it may just as well be the case that the data format of the multimedia data object is not supported. When providing an indication that the multimedia data object cannot be rendered because the amount of energy for rendering the object in full, this problem is solved.

The circuit according to the invention comprises: a rendering circuit for rendering multimedia data objects; and a central processing unit conceived to: provide a list of at least one reference to at least one multimedia data object scheduled for rendering by the rendering circuit; determine the amount of energy needed for rendering the multimedia data object; determine the amount of energy that can be provided by the battery; and have the multimedia data object rendered by the rendering unit when the amount of energy that can be provided by battery is equal to or more than the amount of energy needed for rendering the multimedia data object.

The apparatus according to the invention comprises such circuit and means for providing a multimedia object to the rendering unit.

The invention will be described in more detail by means of various Figures;

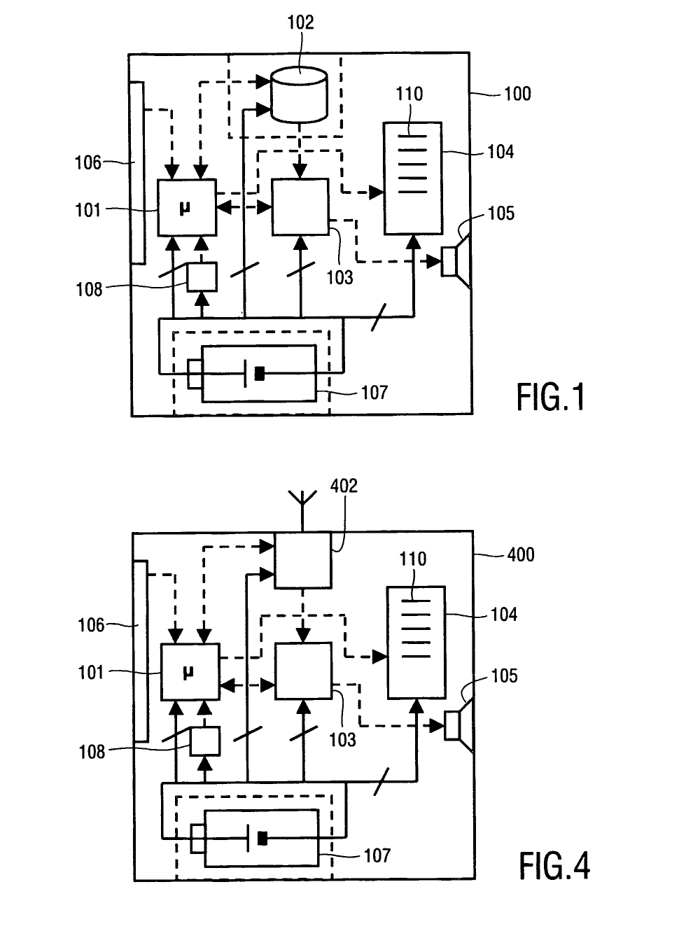

FIG. 1 shows an embodiment of the apparatus according to the invention;

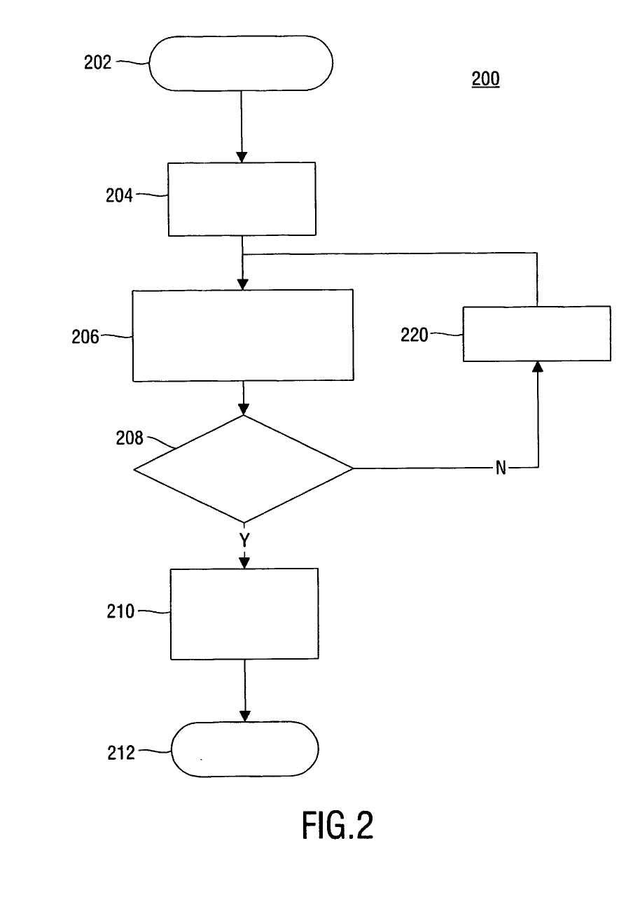

FIG. 2 shows a flowchart 200 depicting an embodiment of the method according to the invention;

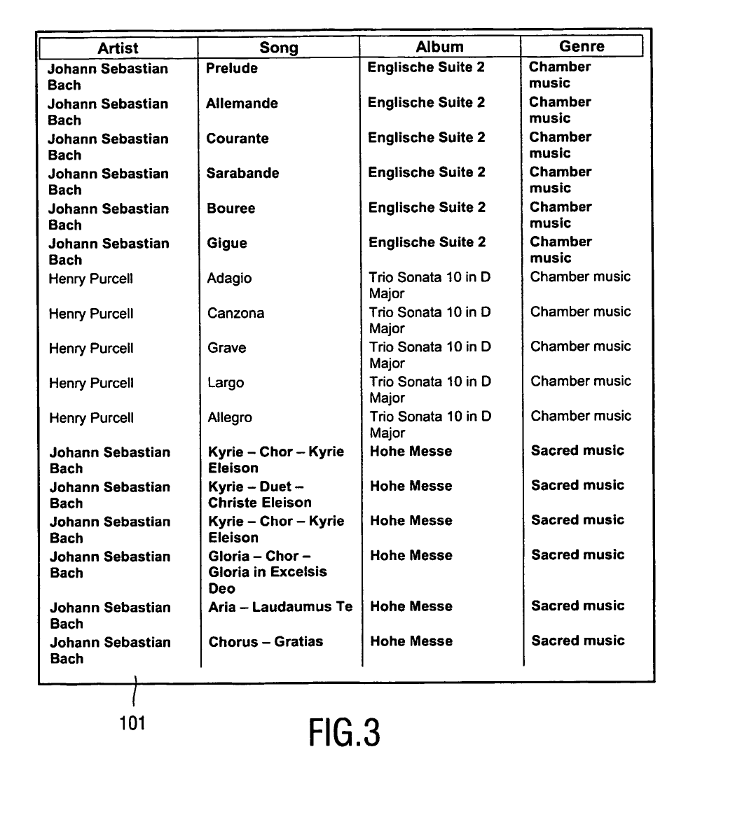

FIG. 3 shows a playlist; and

FIG. 4 shows a second embodiment of the apparatus according to the invention.

The consumer electronics apparatus 100 as shown in FIG. 1 is an embodiment of the apparatus according to the invention and comprises a microprocessor 101 as a central processing unit for controlling various components of the electronics apparatus 100, a harddisk drive 102 as a memory for storing multimedia data objects, a rendering circuit 103 for rendering multimedia data objects, a display 104 for displaying status information of the apparatus 100 and for displaying rendered multimedia data objects, a speaker 105 for reproducing rendered sound information, a user input unit 106 for enabling a user to control the apparatus 100 and a battery 107 for supplying the various components of the apparatus 100 with energy to ensure proper operation. The apparatus also comprises a battery energy monitor 108 for determining the amount of energy in the battery 107. The dashed lines around the harddisk drive 102 indicate that it is removable in this embodiment of the invention.

The dashed lines indicate data transport, the solid lines indicate transport of energy. For the sake of simplicity, the solid lines with a diagonal line indicate a positive as well as a negative wire.

A user is enabled to select multimedia objects for rendering (which may comprise reproduce in the context of this application) by controlling the apparatus 100 by means of the user input unit 106. The user input signals are fed to the micro controller 101. In this way, a list 110 is formed with references to multimedia data objects stored in the memory 102, scheduled for rendering by the rendering unit 103 for display on the display 104 and other means like the speaker 105. The list 110 is displayed on the display 104.

As the apparatus 100 is powered by the battery 107, the amount of energy for powering the apparatus 100 is not infinite. It may well be that only a fraction of the content stored on the harddisk 102 can be rendered with the amount of energy stored in the battery 107. Although the user of the apparatus 100 will probably seldom select all stored multimedia data objects for rendering, a harddisk of 40 GB is able to carry over 600 hours of music, of which perhaps at most 10% can be played back with the amount of energy comprised by a conveniently sized battery. 40 GB stores far less hours of video, but a lot more energy is required for properly rendering and reproducing video.

Therefore, there is a need for prioritization of multimedia data objects to be rendered. Furthermore, it is preferred to select only multimedia data objects for rendering that can be rendered in full with amount of battery energy available; either each multimedia data object or all of them (either sequentially—most preferred for music or video—or in parallel—most preferred for still picture data). When the battery 107 has no more energy left while a multimedia data object is not yet fully rendered, a user may miss vital parts of the multimedia data object, which is very annoying. However, also the miss of apparently less vital, subtle parts of the multimedia data object may in some cases by just as annoying, like for example with a classical concert.

For such cases, a user probably wants to have the multimedia data object rendered either in full or not at all. Therefore, according to the invention, only multimedia data objects are rendered when the amount of energy that can be provided by the battery 107 is equal to or more than the amount of energy needed for rendering the multimedia data object.

The microprocessor 101 and the rendering circuit 103 form an embodiment of the circuit according to the invention.

FIG. 2 shows a flowchart 200 depicting an embodiment of the method according to the invention. The labels of the process steps are indicated in Table 1. The process will be discussed by means of the apparatus 100 in FIG. 1 as well.

| Label | Process step name |
|---|---|
| 202 | Provide list of multimedia data objects for rendering |
| 204 | Determine amount of energy available in battery |
| 206 | Determine amount of energy needed for rendering and reproducing |
| | each multimedia data object referenced in list |
| 208 | Enough energy in battery for objects to render? |
| 210 | Render all multimedia data objects referenced in list |
| 212 | Ready for next list for rendering |
| 220 | Unselect objects in list for rendering |

The process starts at the start point 202 with providing the list 110. This list can be provided in various ways. For example, multiple multimedia data objects can be grouped in one directory on the harddisk drive 102 or a file with references to multimedia data objects can be provided, on the harddisk 102 as well. In this embodiment, all the multimedia data objects referenced in the list 110 are selected for rendering. In a further embodiment, some multimedia data objects are pre-selected and some not.

Subsequently, in a step 204, the amount of energy left in the battery 108 is determined by the battery energy monitor 108. Various methods for doing this are known to persons skilled in the art. Also for this determination, various parameters can be taken into account, for example the ambient temperature and the (expected) average current drawn from the battery, as these kind of parameters influence the amount of energy a battery can deliver.

In a subsequent step 206, for each multimedia data object referenced in the list 110, the amount of energy needed for rendering and reproducing is calculated. Various parameters can be taken into account for determining the amount of energy needed. Examples for parameters are the size of the file, the encoding (or decoding) algorithm, the bitrate at which the data has been encoded or the volume or brightness at which data is being or will be reproduced. But also storage or hardware parameters like the ratio of fragmentation of data on the harddisk 102, the average dissipation of the various components and the ambient temperature can be taken into account.

The order of the step 204 and the step 206 can be swapped or both can be executed in parallel, this is irrelevant for the scope of the invention.

After the amount of energy available for rendering and reproducing and the amount of energy needed for that same purpose, both amounts of energy are compared in a decision process step 208. When the amount of energy needed for rendering of all multimedia data objects referenced in the list can be delivered in full by the battery 108, the process continues to a subsequent step 210.

In the process step 210, all multimedia data objects to which the list 110 comprises a reference are rendered and reproduced by either the display 104 or the speaker 105 or by both, whichever is applicable.

Having rendered all multimedia data objects referenced in the list, the process terminates in the ending point 212 and the apparatus 100 is ready for receiving another list with references to objects to render.

When on the other hand in the decision step 208 it is determined that the amount of energy necessary to properly render all multimedia data objects referenced in the list 110 cannot be provided by the battery 108, the process branches to a process step 220, in which objects in the list 110 are unselected for rendering. In this embodiment of the invention, this is done by unselecting the last reference from the list 110. Having unselected a reference from the list, the amount of energy needed to render the selected items is determined again in the step 206, after which both amount of energy are again compared in the decision step 208. When the amount of energy needed for is still not enough, the next reference is unselected from the list in the process step 220. Steps 206, 208 and 220 are repeated until the amount of energy needed for rendering all multimedia data objects can be provided by the battery 108.

Alternatively, all references to multimedia data objects for which the battery cannot provide enough energy to render them can be unselected at once. In yet another embodiment of the method according to the invention, the choice of unselecting items from the list 110 is left to a user of the apparatus 100. In again a further embodiment, the apparatus 100 stores a user profile on the harddisk 102 and only items least preferred by a user are removed from the list 110. Also another embodiment provides the option that the list 110 is shown on the display 104 and a group of references to multimedia data objects that can be rendered and played back with the available amount of energy is highlighted as shown in FIG. 3. In the depicted example, the user has a preference for music composed by Johann Sebastian Bach.

In again a further embodiment of the method according to the invention, references to multimedia data objects are not unselected in the list 110, but removed from the list 110.

In a default state, the apparatus 100 selects and highlights in the list 110 references to multimedia data objects from the top to the reference to the data object that can still be rendered and reproduced. When the first referenced multimedia data object cannot be played back with the amount of energy available in the battery 108, the subsequent reference to a multimedia data object that can be rendered and reproduced with the available amount of energy is highlighted and selected for playback. Other multimedia data objects are not available for play back, unless a user sets up the apparatus 100 not to execute the method according to the invention.

In a further embodiment of the invention, based on the embodiment described in the previous paragraph, the user can specify to take into account a user profile comprising references to for example a genre, artist or composer. When the list references sonates of various composers in random order and the user prefers those of Schubert, the apparatus 100 (or actually, the microprocessor 101) checks first which sonates of Schubert can be rendered and reproduced, independently of their location in the list 110. When they can all be rendered and reproduced, the microprocessor 101 checks for subsequent multimedia data objects referenced in the list that can be played back with an amount of energy left when all referenced sonata's of Schubert have been played back.

A person skilled in the art will readily appreciate that various selections are possible for selecting objects that can still be rendered with a given amount of energy in the battery 107. They can all have a different profile; for example different selections for multimedia data objects having the same artist or the same genre. In yet a further embodiment, a user can browse through the various selections using the user input unit 106. To this, the user input unit 106 comprises for example a turning knob or left/right cursor buttons. At every push of a button, a different selection of multimedia data objects to be rendered is presented on the display 104. Also, the common denominator of the selected multimedia data objects is displayed, for example the genre.

In again another embodiment of the invention, the various selections multimedia data objects to be rendered are selected in a random way.

It may well be that due to change of environmental parameters, for example the ambient temperature, the amount of energy that could be provided by the battery at first, can after all not be provided by the battery. Therefore, according to an embodiment of the invention, the battery energy monitor 108 monitors the amount of energy left in the battery 107 at regular intervals. When during operation of the apparatus 100 it appears that not all multimedia data objects selected at first by the method depicted in FIG. 2, other references to multimedia data objects are unselected or removed from the list 110.

FIG. 4 shows a further apparatus 400 as another embodiment of the apparatus according to the invention. For the sake of clarity, components that appear in the apparatus 100 as well in the further apparatus 400 have been referenced with the same reference number. In the further apparatus 100, the harddisk drive 102 has been replaced by a communication unit 402 for receiving multimedia data objects for rendering. This embodiment of the apparatus according to the invention makes the embodiment of the method according to the invention as described in the previous paragraph even more important. The reason for this is that with current communication units the amount of energy consumed varies with the distance of the further apparatus 400 from a source (like an antenna) of the multimedia data objects.

Having described various embodiments of the invention, it will be clear to a person skilled in the art that various embodiments of the invention are possible, without departing from the basics of the invention. Those embodiments can be permutations of the embodiments as described above but also other embodiments.

In summary, the invention relates to portable devices for rendering multimedia data objects are widely known; mainly for reproducing audio, but also for reproducing video. These devices are powered by battery, which is known to have a limited amount of energy available. This carries the risk that no energy is available any more, while a multimedia data object that is rendered, is not rendered in full this leaves a user unsatisfied. Therefore, the amount of energy of the battery is checked and when a multimedia data object selected to be rendered can be rendered in full, it is rendered. When it cannot be rendered in full, it is not rendered. In an embodiment according to the invention, this check is made for a group of selected multimedia data objects.

1. Method of rendering multimedia data objects by a rendering circuit (103) powered by a battery (107), comprising the steps of:
a) providing (202) a list (110) of at least one reference to at least one multimedia data object scheduled for rendering by the rendering circuit (103);
b) determining (206) the amount of energy needed for rendering the multimedia data object referenced in the list;
c) determining (204) the amount of energy that can be provided by the battery; and
d) rendering (210) the multimedia data object for rendering when the amount of energy that can be provided by the battery is equal to or more than the amount of energy needed for rendering the multimedia data object.

2. Method according to claim 1, wherein the list comprises a multitude of references to multimedia data objects and the method further comprises the step of selecting a group of multiple multimedia data objects that can be rendered in total with the amount of energy that can be provided by the battery.

3. Method according to claim 2, wherein the selection of the group of multimedia data objects is based on a user preference profile.

4. Method according to claim 1, wherein the apparatus further comprises a display (104) and the method further comprises the steps of:
a) displaying the list on the display; and
b) highlighting all references to multimedia data objects that can each be rendered with the amount of energy that can be provided by the battery.

5. Method according to claim 1, wherein the apparatus further comprises a display and the method further comprises the steps of:
a) displaying the list on the display; and
b) highlighting a group of references to multimedia data objects that can all be rendered with the amount of energy that can be provided by the battery.

6. Method according to claim 2, wherein a user is enabled to browse through multiple groups of references to multimedia objects, each group referencing multimedia objects that can all be rendered in total with the amount of energy that can be provided by the battery.

7. Method according to claim 4, wherein the group of references is highlighted using a user preference profile.

8. Method according to claim 1, wherein the method further comprises the step of indicating that the selected object can be rendered in full with the amount of energy left in the battery.

9. Circuit for rendering multimedia data objects being powered by a battery (107) comprising:
a) a rendering circuit (103) for rendering multimedia data objects;
b) a central processing (101) unit conceived to:
(i) provide a list of at least one reference to at least one multimedia data object scheduled for rendering by the rendering circuit;
(ii) determine the amount of energy needed for rendering the multimedia data object;
(iii) determine the amount of energy that can be provided by the battery; and
(iv) have the multimedia data object rendered by the rendering unit when the amount of energy that can be provided by battery is equal to or more than the amount of energy needed for rendering the multimedia data object.

10. Apparatus (100, 400) for rendering multimedia data objects comprising the circuit according to claim 9 and means (102, 402) for providing a multimedia object to the rendering unit.
